(19) United States
(12) Patent Application Publication
(10) Pub. No.: US 2012/0221773 A1
(43) Pub. Date: Aug. 30, 2012

(54) NONVOLATILE SEMICONDUCTOR MEMORY DEVICE

(75) Inventors: Shinichi SHUTO, Kanagawa (JP); Takayuki Tamura, Kanagawa (JP); Noriyuki Kotani, Kanagawa (JP); Hiroyasu Tominaga, Kanagawa (JP)

(73) Assignee: RENESAS ELECTRONICS CORPORATION

(21) Appl. No.: 13/404,883

(22) Filed: Feb. 24, 2012

(30) Foreign Application Priority Data
Feb. 25, 2011 (JP) 2011-039294

(51) Int. Cl. G06F 12/00

(52) U.S. Cl. 711/103; 711/E12.008

(57) ABSTRACT

The disclosed invention provides a technique for efficiently avoiding read disturbance. A nonvolatile semiconductor memory device includes a nonvolatile memory unit and a controller that can control refresh processing for rewriting data in a block of blocks assumed to be erasable units in the nonvolatile memory unit into anther block different from the block. The controller sets up a first area and a second area different from the first area in the nonvolatile memory unit and, each time a refresh trigger occurs, executes refresh processing for the first area and the second area, such that a refresh frequency of data in the first area will become higher than a refresh frequency of data in the second area. Thereby, it is possible to efficiently avoid read disturbance when read access is repeated.

### CROSS-REFERENCE TO RELATED APPLICATIONS

The disclosure of Japanese Patent Application No. 2011-39294 filed on Feb. 25, 2011 including the specification, drawings and abstract is incorporated herein by reference in its entirety.

### BACKGROUND

The present invention relates to a nonvolatile semiconductor memory device and read disturbance countermeasures in such device, and relates to a technique that is effectively applied to, for example, a NAND flash memory system.

As nonvolatile semiconductor memory devices that are easily rewritable, a NOR flash memory and a NAND flash memory can be named. The NOR flash memory, in which access to all areas is assured, is a memory that is almost free from a problem of read disturbance faults. On the other hand, the NAND flash memory, in which all areas are not always assured to be good blocks, suffers from a problem of read disturbance faults, i.e., data corruption may occur during a continued read operation, but is a memory of lower cost per bit. For systems for an amusement genre, the NOR flash memory has so far been used more commonly than the NAND flash memory as a memory for storing data. Recently, reducing the unit price of a memory has become an important problem because of an increasing amount of data to be stored and instances where the use of the NAND flash memory is considered have increased. Read disturbance is resolved by rewriting data. However, systems for an amusement genre are mainly engaged in reading data, but writing data is little performed or not performed at all. In these systems, there is a possibility that data corruption occurs due to read disturbance during repeated read operations by a host device and countermeasures to read disturbance became necessary. Some of documents in which read disturbance countermeasures are described are Patent Documents 1 and 2.

In Patent Document 1, any number of blocks less than all blocks of a plurality of blocks are rewritten and blocks different from those rewritten the last time are rewritten at each of predetermined timing to avoid repeated errors at a certain location of a flash memory.

In Patent Document 2, access is distributed by multiplexing data, so that read disturbance, if occurs, does not affect data reading.

### RELATED ART DOCUMENTS

[Patent Documents]

[Patent Document 1] Japanese Unexamined Patent Publication No. 2010-015477

[Patent Document 2] Japanese Unexamined Patent Publication No. 2010-152472

### SUMMARY

In the NAND flash memory, in order to avoid read disturbance, data rewrite processing (a series of data reading, ECC (Error-Correcting Code) check, followed by data writing (hereinafter simply referred to as “refresh processing”)) should be performed periodically. However, during a period when data rewrite processing is performed to avoid read disturbance, a read command from a host device cannot be accepted. Hence, in an application in which data read from the host device is performed frequently, data processing in the host device might be disrupted. Although it is conceivable that data rewrite processing to avoid read disturbance is performed in cooperation with the host device, the host device has no knowledge on information about read disturbance in the NAND flash memory, and cooperation with the host device is difficult.

In Patent Document 1, the whole memory area is divided into areas for which refresh is performed in order. However, reading is not performed evenly across the whole user data and some areas have a large read load and other areas have a small read load. How to cope with areas with different read loads is not suggested.

In Patent Document 2, mirror areas are created and user data is multiplexed. However, if data is simply multiplexed, a larger amount of memory area would be consumed, which could result in an increase in the memory cost.

An object of the present invention is to provide a technique for efficiently avoiding read disturbance.

The above-noted and other objects and novel features of the present invention will become apparent from the following description in the present specification and the accompanying drawings.

A typical aspect of the invention disclosed in this application is summarized as follows.

A nonvolatile semiconductor memory device includes a nonvolatile memory unit and a controller that can control refresh processing for rewriting data in a block of blocks assumed to be erasable units in the nonvolatile memory unit into anther block different from the block. The controller sets up a first area and a second area different from the first area in the nonvolatile memory unit and, each time a refresh trigger occurs, executes refresh processing for the first area and the second area, such that a refresh frequency of data in the first area will become higher than a refresh frequency of data in the second area.

Effect that will be achieved by a typical aspect of the invention disclosed herein is briefly described below.

It is possible to efficiently avoid read disturbance when read operations are repeated.

### BRIEF DESCRIPTION OF THE DRAWINGS

FIG. 1 is a block diagram showing a configuration example of a flash memory system, presented as one example of a nonvolatile semiconductor memory device pertaining to the present invention.

FIG. 2 is an explanatory diagram for read disturbance (hereinafter abbreviated to “RD”) refresh processing.

FIG. 3 is an explanatory diagram for RD refresh processing.

FIG. 4 is an explanatory diagram for division of the memory area of a NAND flash memory.

FIG. 5 is an explanatory diagram for division of the memory area of a NAND flash memory.

FIG. 6 is an explanatory diagram for order in which RD refresh processing is performed.

FIG. 7 is an explanatory diagram for allocating data to a high load area.

FIG. 8 is an explanatory diagram for transferring data in error to a high load area.

FIG. 9 is an explanatory diagram for registering the address of a block in which an error has occurred into an address registry area.

FIG. 10 is an explanatory diagram for registering the address of a block in which an error has occurred into an address registry area.

FIG. 11 is an explanatory diagram for multiplexing data.

FIG. 12 is an explanatory diagram for multiplexing data.

FIG. 13 is an explanatory diagram for multiplexing data.

FIG. 14 is an explanatory diagram for subdivision into high load and low load area.

FIG. 15 is an explanatory diagram for order in which RD refresh processing is performed.

FIG. 16 is a block diagram showing another configuration example of a flash memory system, presented as one example of a nonvolatile semiconductor memory device pertaining to the present invention.

### DETAILED DESCRIPTION

### 1. General Outline of Embodiments

To begin with, exemplary embodiments of the present invention disclosed herein are outlined. In the following general description of exemplary embodiments, reference designators (numerals) in the drawings, which are given for referential purposes in parentheses, are only illustrative of elements that fall in the concepts of the components identified by the designators.

[1] A nonvolatile semiconductor memory device (1) pertaining to an exemplary embodiment of the present invention includes a nonvolatile memory unit (11) and a controller (12) that can control refresh processing for rewriting data in a block of blocks assumed to be erasable units in the nonvolatile memory unit into anther block different from the block. The controller sets up a first area and a second area different from the first area in the nonvolatile memory unit and, each time a refresh trigger occurs, executes refresh processing for the first area and the second area, such that a refresh frequency of data in the first area will become higher than a refresh frequency of data in the second area. By executing the refresh processing as above, the refresh frequency of data in the first area becomes higher than the refresh frequency of data in the second area. Thus, for example, by storing data that is particularly often accessed and read into the first area, it is possible to efficiently avoid read disturbance when read access is repeated.

[2] In the nonvolatile semiconductor memory device set forth in [1], the controller may preferably be configured to, after correcting data in error, move the data to the first area in order to cope with user's oversight and unexpected read access.

[3] In the nonvolatile semiconductor memory device set forth in [2], the refresh trigger includes input of a predefined command from outside and an existing, command to the nonvolatile semiconductor memory device is used as the predefined command. When an address exceeding a maximum address in the nonvolatile semiconductor memory device has been specified by the existing command, the controller regards the existing command as a command to initiate the refresh processing. In this case, it is advantageous that there is no need to alter commands configured in a host system (2).

[4] In the nonvolatile semiconductor memory device set forth in [3], the controller may be configured to multiplex data in the first area. Further, the controller may be configured to execute data rewriting, if the number of times of rewriting for a block to which data should be rewritten in the refresh processing is less than an upper limit for the number of times of rewriting depending on the number of times of power-on, and abort the data rewriting, if the number of times of rewriting for the block to which data should be rewritten has reached the upper limit for the number of times of rewriting depending on the number of times of power-on. Accordingly, because the nonvolatile semiconductor memory device is capable of limiting excessive rewriting by itself, the host system can issue a command for refresh without taking account of the number of times of rewriting for the nonvolatile memory unit (11).

[5] In the nonvolatile semiconductor memory device set forth in [1], the controller may be configured to multiplex data in the first area.

[6] In the nonvolatile semiconductor memory device set forth in [4], data within a same block in the first area may preferably be multiplexed in order to shorten the time to move data.

[7] In the nonvolatile semiconductor memory device set forth in [1], the controller may be configured to execute data rewriting, if the number of times of rewriting for a block to which data should be rewritten in the refresh processing is less than an upper limit for the number of times of rewriting depending on the number of times of power-on, and abort the data rewriting, if the number of times of rewriting for the block to which data should be rewritten has reached the upper limit for the number of times of rewriting depending on the number of times of power-on. Accordingly, because the nonvolatile semiconductor memory device is capable of limiting excessive rewriting by itself, the host system can issue a command for refresh without taking account of the number of times of rewriting for the nonvolatile memory unit (11).

[8] A nonvolatile semiconductor memory device (1) pertaining to an exemplary embodiment of the present invention includes a nonvolatile memory unit (11) and a controller (12) that can control refresh processing for rewriting data in a block of blocks assumed to be erasable units in the nonvolatile memory unit into another block different from the block. An address registry area is provided in the nonvolatile memory unit. The controller registers for management an area of the nonvolatile memory unit, the area in which an error occurrence has been found during the refresh processing into the address registry area. Moreover, each time a refresh trigger occurs, the controller executes refresh processing for the first area and the second area, such that a refresh frequency for the area registered in the address registry area will become higher than a refresh frequency of data in an area not registered in the address registry area. Accordingly, it is possible to efficiently avoid read disturbance when read access is repeated.

[9] In the nonvolatile semiconductor memory device set forth in [8], the controller may be configured to register for management an area of the nonvolatile memory unit, the area in which an error occurrence has been found during the refresh processing into the address registry area in another semiconductor chip different from a semiconductor chip to which that area belongs.

[10] In the nonvolatile semiconductor memory device set forth in [9], the controller may multiplex data in the first area. Further, the controller executes data rewriting, if the number of times of rewriting for a block to which data should be rewritten in the refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on. Accordingly, because the nonvolatile semiconductor memory device is capable of limiting excessive rewriting by itself, the host system can issue a command for refresh without taking account of the number of times of rewriting for the nonvolatile memory unit (11).

[11] In the nonvolatile semiconductor memory device set forth in [8], the refresh trigger includes input of a predefined command from outside and an existing command to the nonvolatile semiconductor memory device is used as the predefined command. When an address exceeding a maximum address in the nonvolatile semiconductor memory device has been specified by the existing command, the controller regards the existing command as a command to initiate the refresh processing. In this case, it is advantageous that there is no need to alter commands configured in a host system (2).

[12] In the nonvolatile semiconductor memory device set forth in [8], the controller may multiplex data in the first area.

[13] In the nonvolatile semiconductor memory device set forth in [11], data within a same block in the first area may preferably be multiplexed in order to shorten the time to move data and reduce the load for read disturbance countermeasures.

[14] In the nonvolatile semiconductor memory device set forth in [8], the controller may be configured to execute data rewriting, if the number of times of rewriting for a block to which data should be rewritten in the refresh processing is less than an upper limit for the number of times of rewriting depending on the number of times of power-on, and abort the data rewriting, if the number of times of rewriting for the block to which data should be rewritten has reached the upper limit for the number of times of rewriting depending on the number of times of power-on. Accordingly, because the nonvolatile semiconductor memory device is capable of limiting excessive rewriting by itself, the host system can issue a command for refresh without taking account of the number of times of rewriting for the nonvolatile memory unit (11).

[15] A nonvolatile semiconductor memory device (1) pertaining to an exemplary embodiment of the present invention includes a nonvolatile memory unit (11) and a controller (12) that can control refresh processing for rewriting data in a block of blocks assumed to be erasable units in the nonvolatile memory unit into another block different from the block. The controller executes data rewriting, if the number of times of rewriting for a block to which data should be rewritten in the refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.

### 2. Details on Embodiments

Some embodiments of the invention now will be described in further detail.

### FIRST EMBODIMENT

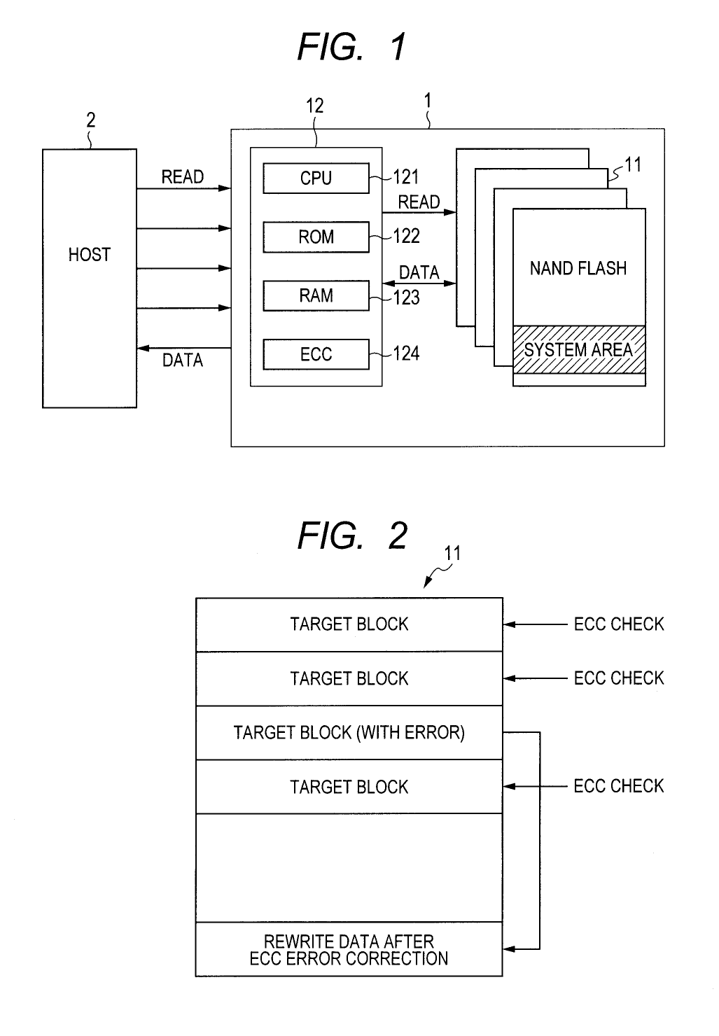

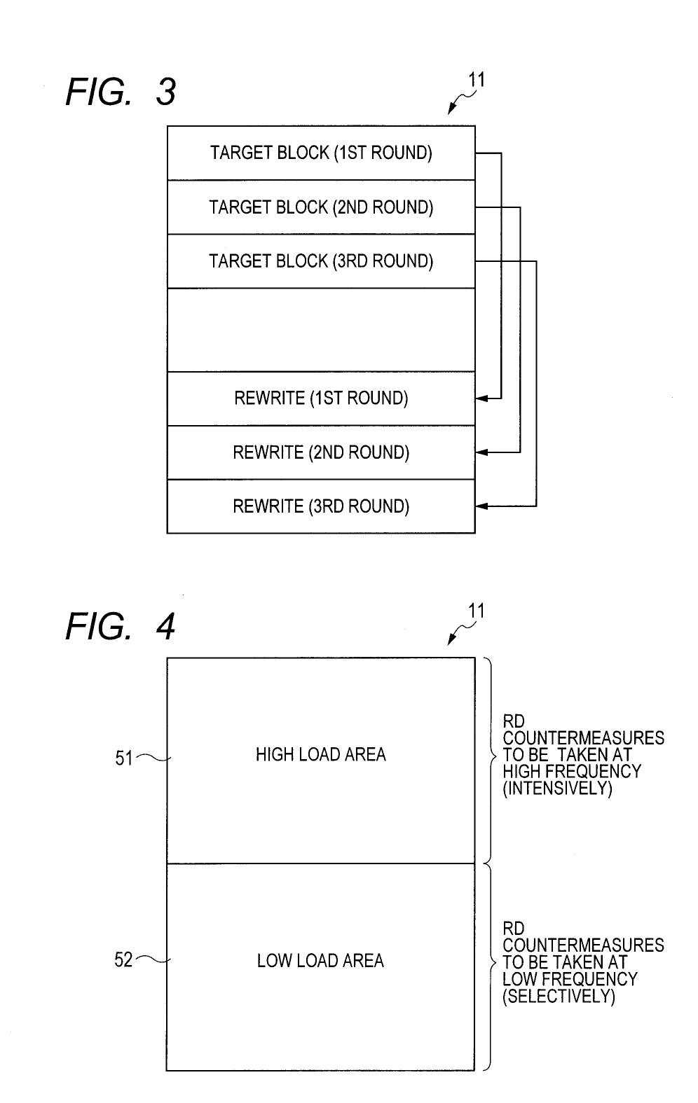

FIG. 1 shows a configuration example of a flash memory system, presented as one example of a nonvolatile semiconductor memory device pertaining to the present invention. The flash memory system 1 includes a plurality of NAND flash memories (nonvolatile memory units) 11 and a controller 12 and is coupled to a host system (simply referred to as a “host”) 2. Although not restrictive, the host 2 is assumed to be a control device in a system for an amusement genre such as a gaming system or a Pachinko (Japanese pinball) system. The NAND flash memories 11 can be read/written by the host 2. In the NAND flash memories 11, various kinds of data that are required by the host 2, such as image data to be displayed by the host 2, are store. Moreover, there is a system area in each of the NAND flash memories 11. In this system area, variables for implementing various functions in the NAND flash memories 11, for example, information specifying a high load area and a low load area, a threshold for ECC decision, information about refreshing frequency, etc. are stored. These values are rewritable at a shipment test or the like and configured according to customer demand. The NAND flash memories 11 and the controller 12 are each formed in a single semiconductor substrate such as, for example, a single-crystal silicon substrate by means of a publicly known semiconductor integrated circuit manufacturing technology. Writing data into the NAND flash memories 11 and reading data from the NAND flash memories 11 are performed via the controller 12. A unit in which data is to be written into the NAND flash memories 11 is referred to as a “page” and a unit in which data is to be erased is referred to as a “block”. The controller 12 interprets a command given from the host 2 and performs control of operation of the NAND flash memories 11. This controller 12 includes, but not limited to, a CPU (Central Processing Unit) 121, a ROM (Read Only Memory) 122, a RAM (Random Access Memory) 123, and an ECC (Error Checking and Correcting) circuit 124. In the ROM 122, programs that are executed by the CPU 121 are stored. The CPU 121 performs control of operations of all components by executing a program stored within the ROM 122. The RAM 123 is used as a working area or the like for the CPU 121 when a program is executed. The ECC circuit 124 detects and corrects a code error (error) if such error has occurred in data being read from the NAND flash memories 11.

In the following paragraphs, descriptions are provided about countermeasures for efficiently avoiding read disturbance when read access is repeated.

For the NAND flash memories 11, RD refresh processing is performed to avoid read disturbance. Essentially, RD refresh processing can be classified into “rewriting data selectively” and “rewriting data each time”.

Rewriting data selectively is started, triggered by a predefined command provided from the host 2 or power-on reset of the flash memory system 1. In the case of rewriting data selectively, for example, as shown in FIG. 2, data in a target area is read and ECC checked. For a block in which an ECC error has been detected (a block with an error), rewriting the data in the block is performed after the error is corrected. This rewrite operation rewrites the data into a block that is different from the block from which the data has been read in order to avoid loss of the data due to power-off or the like.

Rewriting data each time is started, triggered by a predefined command provided from the host 2 or power-on reset of the flash memory system 1, in a case that read access is more often performed. In the case of rewriting data each time, each time refreshing is triggered as above, data in a target area is read and rewritten independently of a result of ECC check.

In each case of rewriting data selectively and rewriting data each time, the size of the target area (the number of blocks) to undergo processing at a time is determined as demanded by the host 2.

The above RD refresh processing is described more specifically.

Timing of RD refresh processing is controlled by the controller 12 in a manner described below.

As RD refresh processing is performed in cooperation with the host 2, it is started, triggered by a predefined command provided from the host 2 or power-on reset of the flash memory system 1 and a rewrite operation is performed at timing as described below. RD refresh processing should be terminated within a time permitted for the host 2.

The predefined command to start RD refresh processing may be an existing command, for example, a read command that can be used for this purpose. In a case where an “ordinarily impossible address” has been specified in this read command, the controller 12 regards it as a RD refresh command. Here, the “ordinarily impossible address”, for example, may be an address that exceeds a maximum address in the flash memory system 1. In a case where an address that exceeds the maximum address in the flash memory system 1 has been specified by the read command, this normally would become a command error, but the controller 12 regards it as the RD refresh command and starts RD refresh processing in response to the command trigger. By using a read command in this way, it is possible to enable RD refresh processing triggered by the host without modifying the existing host 2.

Then, memory area division is explained.

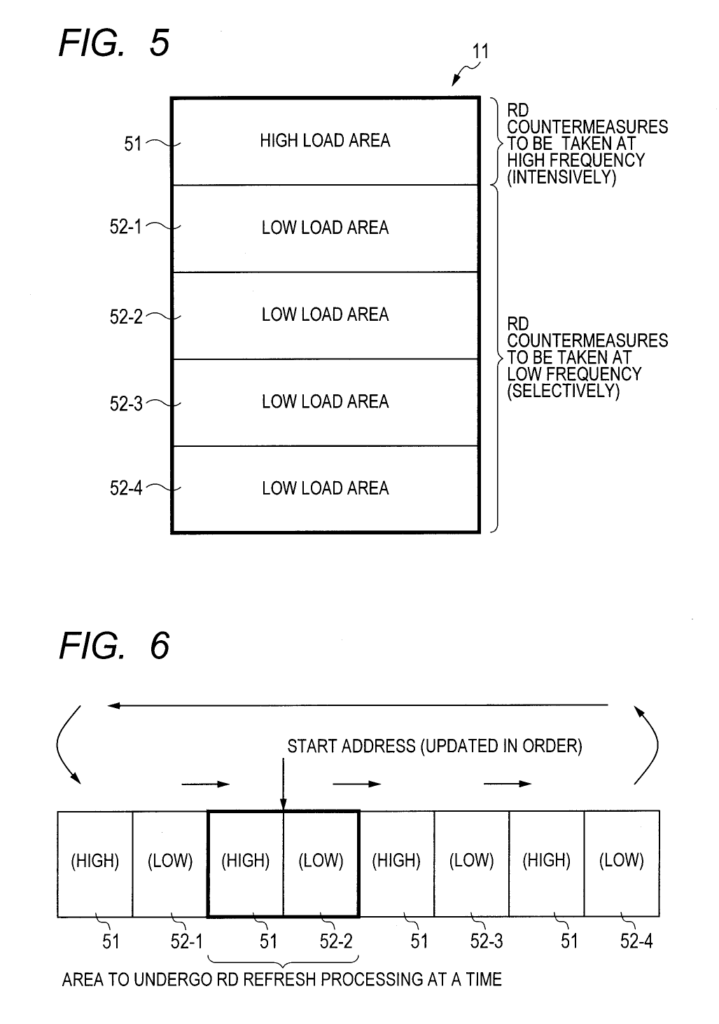

Read load of a NAND flash memory 11 is not even across the whole memory area. Simply rewriting the whole area takes too long time and is not practicable and it is required to make RD refresh processing efficient. Thus, the memory area of a NAND flash memory 11 is divided according to read load, so that RD refresh processing depending on read load is carried out. For example, as shown in FIG. 4, the memory area of a NAND flash memory 11 is divided into a high load area 51 and a low load area 52 and RD refresh processing is performed intensively for the high load area 51. Setup of the high load area 51 and the low load area 52 is executed by the controller 12, for example, upon power-on reset of the flash memory system 1. For the high load area 51, RD refresh processing is performed, each time an RD refresh command is input or each time power-on reset of the flash memory system 1 is done. On the other hand, RD refresh processing is selectively performed for the low load area 52. Such RD refresh processing is controlled by the controller 12. By allowing RD refresh processing depending on read load to be carried out in this way, an improvement in the efficiency of RD refresh processing can be achieved. Besides, the low load area can be subdivided into a plurality of areas. For example, as shown in FIG. 5, the memory area of a NAND flash memory 11 may be divided into a high load area 51 and low load areas 52-1, 52-2, 52-3, 52-4, so that RD refresh processing is intensively performed for the high load area 51, whereas RD refresh processing is selectively performed for the low load areas 52-1, 52-2, 52-3, 52-4.

Then, in order to efficiently carry out RD refresh processing in high load and low load areas, an RD refresh processing start address is defined. RD refresh processing is started at this RD refresh processing start address and performed in sequence. To distribute target areas for RD refresh processing, the RD refresh processing start address should be updated in order. For example, an RD refresh start address is registered in the system area of the NAND flash memory 11. Upon power-on reset, the RD refresh start address registered in the system area of the NAND flash memory 11 can be changed. The RD refresh start address registered in the system area of the NAND flash memory 11 is loaded into the RAM 123 upon power-on reset. Then, this RD refresh start address stored in the RAM 123 is updated in order, each time RD refresh processing is performed, but it is not fed back to the system area of the NAND flash memory 11. More specifically, RD refresh processing is performed as described below.

Assuming that the memory area is divided as shown in FIG. 5 and the high load area 51 occupies 20% of the whole memory area and the low load area 52 occupies 80% (20% for each of the four subdivisions) of the whole memory area, a case that an area of 40% is to undergo RD refresh processing by a single execution of refresh processing is discussed. Such refresh frequency information is stored in the system area of the NAND flash memory 11. In this case, for example, as shown in FIG. 6, the high load area 51 and a low load area 52-2 undergo RD refresh processing at a time and, in turn, the high load area 51 and a low load area 52-3 undergo RD refresh processing at a time. Then, the high load area 51 and a low load area 52-4 undergo RD refresh processing at a time and, in turn, the high load area 51 and a low load area 52-1 undergo RD refresh processing at a time. Subsequently, RD refresh processing is repeated in a similar manner. According to this manner of RD refresh processing, the high load area 51 undergoes RD refresh processing each time, whereas, as for the low load areas 52, four executions of RD refresh processing complete refreshing of all the low load areas 52-1, 52-2, 52-3, 52-4. Thereby, the refresh frequency for data in the high load area becomes higher than the refresh frequency for data in the low, load areas.

Allocating data to high load and low load areas is explained.

Data can be allocated to high load and low load areas in the following methods: a first method in which the user allocates data by design; a second method in which data in error is transferred to a high load area; and a third method that is a combination of the first method and the second method.

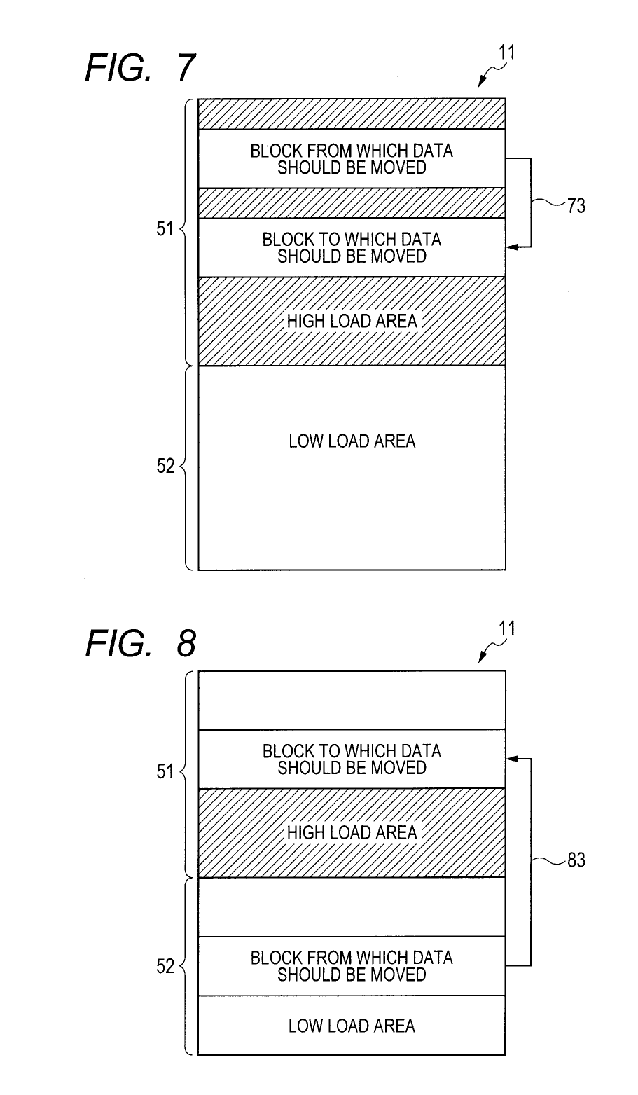

FIG. 7 illustrates the first method in which the user allocates data by design.

The user can allocate data that is often accessed and read to the high load area 51 by design. In the example illustrated in FIG. 7, data that is often accessed and read (data in a block from which data should be moved) is allocated to a block to which data should be moved in the high load area 51 (73). Because RD refresh processing is performed for the high load area 51, each time the RD refresh command is input, or each time power-on reset of the flash memory system 1 is done, such data is sure to be refreshed by the RD refresh processing.

FIG. 8 illustrates the second method in which data in error is transferred to a high load area.

The high load area 51 is initially empty and, when an error has occurred in a block in the low load area 52, the data in error is at once moved to the high load area 51 by the CPU 121. In the example illustrated in FIG. 8, an error has occurred in data in a block from which data should be moved in the low load area 52 and the data in error is moved to a block to which data should be moved in the high load area 51 by the CPU 121. In this way, according to the second method in which data in error is moved to the block to which data should be moved in the high load area 51 by the CPU 121, it is possible to cope with user's oversight and unexpected read access.

Moreover, in the third method that is a combination of the first method and the second method, the user locates data that is often accessed and read in the high load area 51, while a certain amount of empty area is reserved in the high load area 51 and data in error is at once moved to the empty area in the high load area 51 by the CPU 121. Accordingly, the data located in the high load area is sure to be refreshed by RD refresh processing and it is also possible to cope with user's oversight and unexpected read access.

### SECOND EMBODIMENT

In the flash memory system 1 shown in FIG. 1, management of blocks in which an error has occurred is discussed.

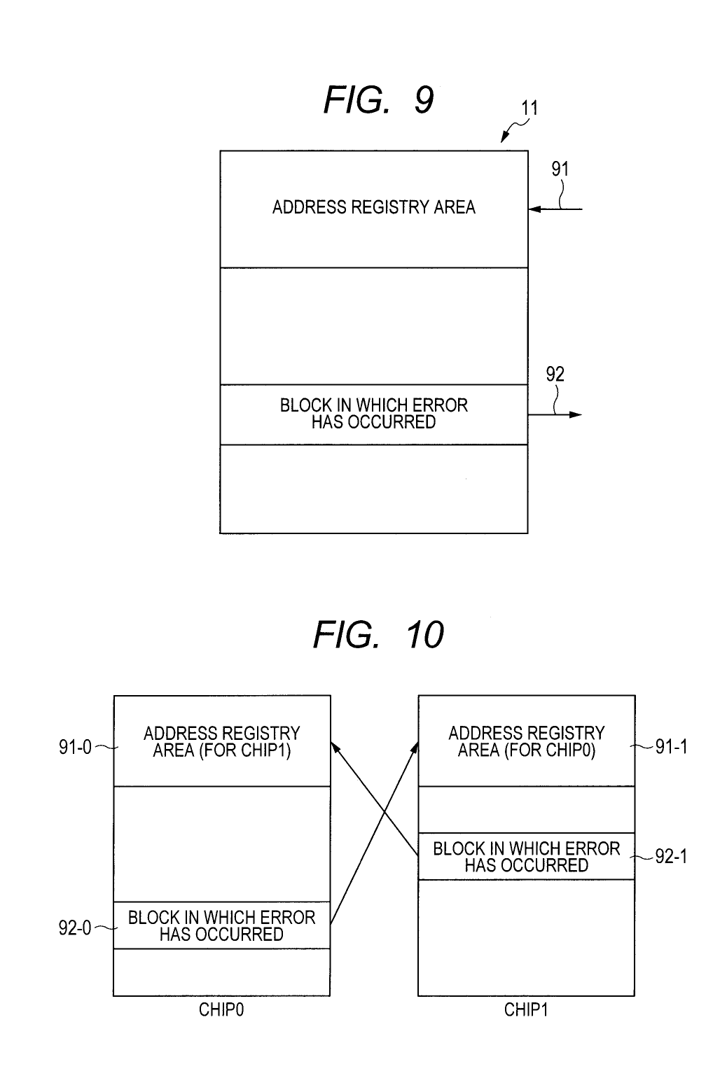

As shown in FIG. 9, an address registry area 91 is provided in the system area of the NAND flash memory 11 and the address of a block in which an error has occurred can be registered in the address registry area 91 and managed. That is, when the CPU 121 has identified an error during RD refresh processing, it registers the address of a block in which the error has occurred 92 into the address registry area 91. The block in which the error has occurred 92 is treated in the same manner as for a block located in the high load area 51. That is, the block in which the error has occurred 92 registered in the address registry area 91 undergoes RD refresh processing, each time the RD refresh command is input, or each time power-on reset of the flash memory system 1 is done. A block not registered in the address registry area 91 is treated in the same manner as for a block located in the low load area 52. Thereby, it is possible to efficiently avoid read disturbance when read access is repeated. Besides, because the CPU 121 can know which block in which an error has occurred by reading the address registry area 91, it can search for a target block for RD refresh processing more quickly.

If there are a block in which an error has occurred 92 and the address registry area 91 in which the block should be registered in a same semiconductor chip, a read operation for RD refresh processing in that semiconductor chip is disabled during a period in which the block in which the error has occurred 92 is registered in the address registry area 91. To avoid this, the address of the block in which the error has occurred should be registered in an address registry area in another semiconductor chip. For example, as shown in FIG. 10, in a case where the flash memory system 1 includes semiconductor chips Chip0, Chip1, an address registry area 91-0 for Chip1 is provided in Chip0 and an address registry area 91-1 for Chip0 is provided in Chip1. The CPU 121 registers the address of a block in which an error has occurred 92-0 in Chip0 into the address registry area 91-1 in Chip1 and registers the address of a block in which an error has occurred 92-1 in Chip1 into the address registry area 91-0 in Chip0. By this, a read operation in the semiconductor chip Chip0 becomes enabled, while the address of the block in which an error has occurred 92-0 in the semiconductor chip Chip0 is being registered into the address registry area 91-1 in the semiconductor chip Chip1. Likewise, a read operation in the semiconductor chip Chip1 becomes enabled, while the address of the block in which an error has occurred 92-1 in the semiconductor chip Chip1 is being registered into the address registry area 91-0 in the semiconductor chip Chip0.

### THIRD EMBODIMENT

In the flash memory system 1 shown in FIG. 1, multiplexing data in a high load area is explained.

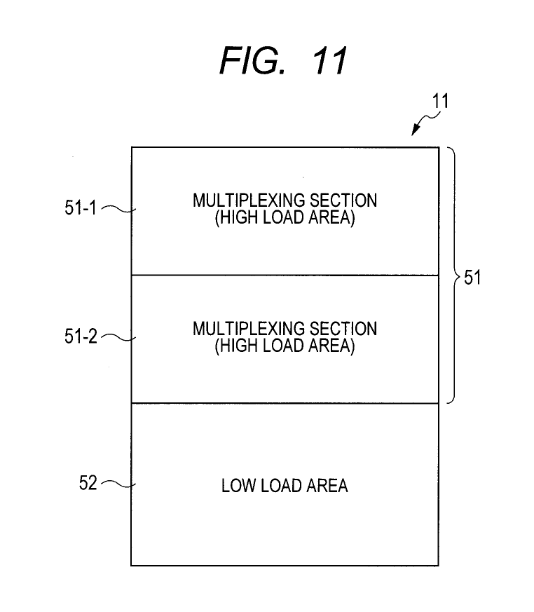

By multiplexing data that is expected to be accessed and read frequently, read access can be distributed. For example, as shown in FIG. 11, the controller 12 manages multiplexing sections 51-1, 51-2 into which the high load area 51 is divided. Data in the high load area 51 is multiplexed and stored in the multiplexing sections 51-1, 51-2, respectively. That is, original data is stored in the multiplexing section 51-1 and copy data of the original data is stored in the multiplexing section 51-2, so that same data can be retrieved by access to any one of the multiplexing sections 51-1, 51-2. Thereby, read access can be distributed between the multiplexing sections 51-1, 51-2.

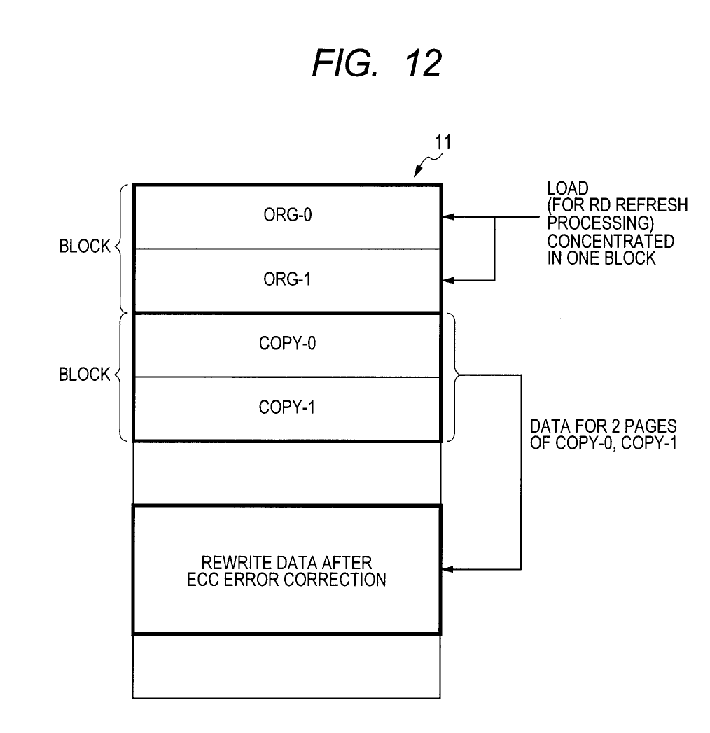

In a high load area, data can be multiplexed on a block-by-block basis. For example, as shown in FIG. 12, data is multiplexed by storing original data Org-0, Org-1 and its copy data Copy-0, Copy-1 in respective separate blocks. In RD refresh processing, data to be read is all data in one block. For example, data for two pages of copy data Copy-0, Copy 1 in one block is read and rewritten into anther block after ECC error correction. Consequently, load is concentrated in one block, when reading original data or copy data.

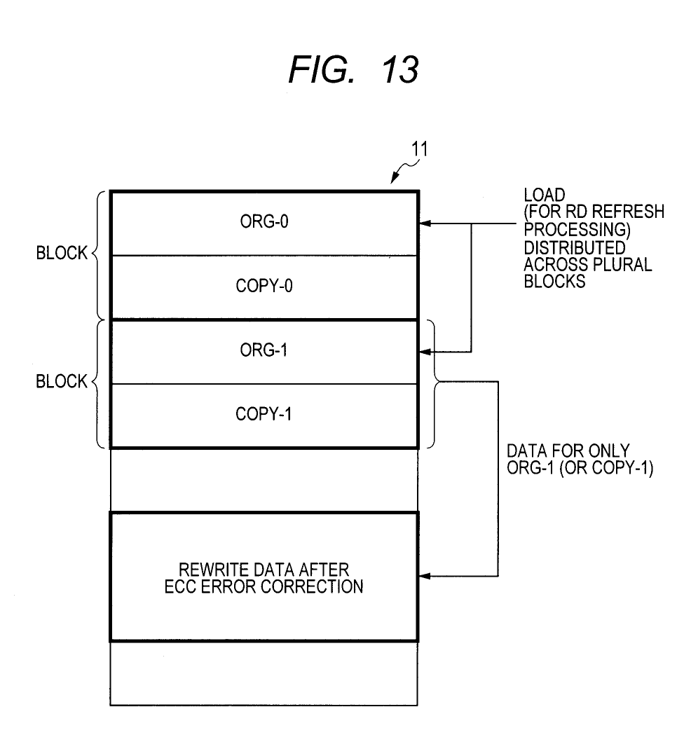

Moreover, in a high load area, data can be multiplexed within a single block. For example, as shown in FIG. 13, original data Org0 and its copy data Copy-0 are multiplexed by storing them into a same block and original data Org-1 and its copy data Copy-1 are multiplexed by storing them into a same block. In this case, data to be read in RD refresh processing is just one-half of data to be read in the case shown in FIG. 12. For example, because original data Org-1 and its copy data Copy-1 in one block are identical, it is only required to read either original data Org-1 or its copy data Copy-1. Similarly, because original data Org-0 and its copy data Copy-0 in one block are identical, it is only required to read either original data Org-0 or its copy data Copy-0. In this way, according to the data multiplexing scheme as illustrated in FIG. 13, the amount of data to be read for RD refresh processing can be reduced to a half, as compared with the data multiplexing scheme as illustrated in FIG. 12. Thus, it is possible to achieve shortening data read time and reducing the frequency of read access per block.

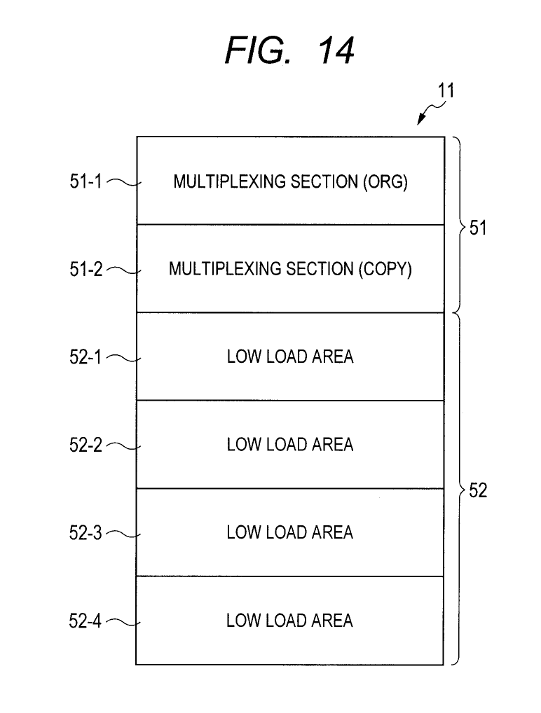

As shown in FIG. 14, the high load area 51 can be subdivided into multiplexing sections 51-1, 51-2 and the low load area 52 can be subdivided into low load areas 52-1, 52-2, 52-3, 52-4. In this case, RD refresh processing is intensively performed for the multiplexing section 51-1, 51-2 (high load area 51) and RD refresh processing is selectively performed for the low load areas 52-1, 52-2, 52-3, 52-4.

In order to efficiently perform RD refresh processing in the multiplexing sections 51-1, 51-2 (high load area 51) and the low load areas 52-1, 52-2, 52-3, 52-4, an RD refresh processing start address is defined. RD refresh processing is started at this RD refresh processing start address and performed in sequence. To distribute target areas for RD refresh processing, the RD refresh processing start address should be updated in order. For example, an RD refresh start address is registered in the system area of the NAND flash memory 11. Upon power-on reset, the RD refresh start address registered in the system area of the NAND flash memory 11 can be changed. The RD refresh start address registered in the system area of the NAND flash memory 11 is loaded into the RAM 123 upon power-on reset. Then, this RD refresh start address stored in the RAM 123 is updated in order, each time RD refresh processing is performed, but it is not fed back to the system area of the NAND flash memory 11. More specifically, RD refresh processing is performed as described below.

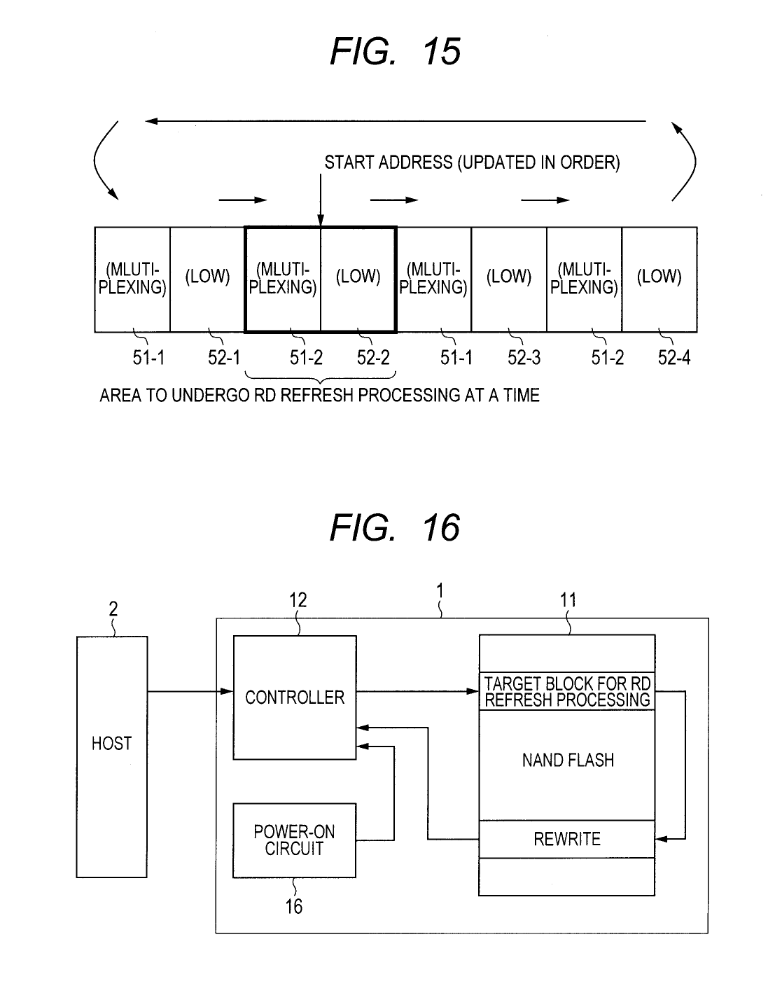

Assuming that the memory area is divided as shown in FIG. 14 and the high load area 51 occupies 33% (16% for each of the two subdivisions) of the whole memory area and the low load area 52 occupies 67% (16% for each of the four subdivisions) of the whole memory area, a case that an area of 33% is to undergo RD refresh processing by a single execution of refresh processing is discussed. Such refresh frequency information is stored in the system area of the NAND flash memory 11. In this case, for example, as shown in FIG. 15, a multiplexing section 51-2 and a low load area 52-2 undergo RD refresh processing at a time and, in turn, a multiplexing section 51-1 and a low load area 52-3 undergo RD refresh processing at a time. Then, the multiplexing section 51-2 and a low load area 52-4 undergo RD refresh processing at a time and, in turn, the multiplexing section 51-1 and a low load area 52-1 undergo RD refresh processing at a time. Subsequently, RD refresh processing is repeated in a similar manner. According to this manner of RD refresh processing, a half of the high load area 51 undergoes RD refresh processing each time, whereas, as for the low load areas 52, four executions of RD refresh processing complete refreshing of all the low load areas 52-1, 52-2, 52-3, 52-4. In other words, RD refresh processing is intensively performed for the high load area 51 and RD refresh processing is selectively performed for the low load area 52.

### FOURTH EMBODIMENT

FIG. 16 shows another configuration example of a flash memory system, presented as one example of a nonvolatile semiconductor memory device pertaining to the present invention. The flash memory system 1 shown in FIG. 16 significantly differs from that shown in FIG. 1 in a point that a power-on circuit 16 is provided. The power-on circuit 16 has a function that maintains the power-on count of the flash memory system 1 (the number of times the system has been powered on). This function is realized by register that can be read and written by the CPU 121 (see FIG. 1) in the controller 12. The power-on count (the number of times the system has been powered on) information is held in the system area of the NAND flash memory 11 and it is loaded to the power-on circuit 16 upon power-on reset by the CPU 121 and then incremented. When the power of the NAND flash memory 11 is turned off, the power-on count maintained by the power-on circuit 16 is fed back to the system area of the NAND flash memory 11, by which the power-on count information within the NAND flash memory 1 is updated.

Here, when an RD refresh command is issued by the host 2, the controller 12 executes reading data from a target block for RD processing according to the RD refresh command and an ECC check on the data. For a block in which an ECC error has been detected, after the error is corrected, rewriting the data into another block is performed. If read access occurs frequently (in a high load area), rewriting data is performed each time, independently of a result of ECC check.

To carry out RD countermeasures certainly, the host 2 must issue a sufficient number of RD refresh commands. However, an excessive number of RD refresh commands, if issued by the host 2, might result in data rewriting that exceeds an upper limit for the number of times of rewriting for the NAND flash memory 11. Especially, when read access occurs frequently (in a high load area), because rewriting data is performed each time, independently of a result of ECC check, data rewriting may be likely to exceed an upper limit for the number of times of rewriting for the NAND flash memory 11.

From a relationship between the life space of a product (in this example, a system for an amusement genre such as a gaming system or a Pachinko (Japanese pinball) system) to which the NAND flash memory 11 is applied and a limitation for the number of times of rewriting for the NAND flash memory 11, an upper limit for the number of times of rewriting per day for the NAND flash memory 11 can be predicted. If the number of times of power-on per day for the NAND flash memory 11 is nearly fixed, like a system for an amusement genre such as a gaming system or a Pachinko (Japanese pinball) system, un upper limit for the number of times of rewriting can be estimated depending on the number of times of power-on for the NAND flash memory 11. Thus, when data rewriting to a block in the NAND flash memory 11 is going to be performed, the controller 12 determines whether or not to execute the data rewriting, based on the number of times of rewriting and the number of times of power-on for the block to which data should be rewritten. The number of times of rewriting for the block to which data should be rewritten is stored in the system area of the NAND flash memory 11. The controller 12 executes the data rewriting, if the number of times of rewriting for the block to which data should be rewritten is less than the upper limit for the number of times of rewriting depending on the number of times of power-on. However, the controller aborts the data rewriting this time, if the number of times of rewriting for the block to which data should be rewritten has reached the upper limit for the number of times of rewriting depending on the number of times of power-on. In this way, because a limitation is placed on data rewriting for the NAND flash memory 11, the host 2 can issue an RD refresh command without taking account of the number of times of rewriting for the NAND flash memory 11.

While the invention made by the present inventors has been described specifically based on its embodiments hereinbefore, it will be obvious that the present invention is not limited to the described embodiments and various modifications may be made without departing from the scope of the invention.

What is claimed is:

1. A nonvolatile semiconductor memory device comprising:
a nonvolatile memory unit; and
a controller that can control refresh processing for rewriting data in a block of blocks assumed to be erasable units in said nonvolatile memory unit into another block different from the block,
wherein said controller sets up a first area and a second area different from the first area in said nonvolatile memory unit and, each time a refresh trigger occurs, executes refresh processing for said first area and said second area, such that a refresh frequency of data in said first area will become higher than a refresh frequency of data in said second area.

2. The nonvolatile semiconductor memory device according to claim 2, wherein said controller, after correcting data in error, moves the data to said first area.

3. The nonvolatile semiconductor memory device according to claim 2,
wherein said refresh trigger includes input of a predefined command from outside,
wherein an existing command to said nonvolatile semiconductor memory device is used as said predefined command, and
wherein when an address exceeding a maximum address in said nonvolatile semiconductor memory device has been specified by said existing command, said controller regards said existing command as a command to initiate said refresh processing.

4. The nonvolatile semiconductor memory device according to claim 3, wherein said controller multiplexes data in said first area and said controller executes data rewriting, if the number of times of rewriting for a block to which data should be rewritten in said refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.

5. The nonvolatile semiconductor memory device according to claim 1, wherein said controller multiplexes data in said first area.

6. The nonvolatile semiconductor memory device according to claim 4, wherein said controller multiplexes data within a same block in said first area.

7. The nonvolatile semiconductor memory device according to claim 1, wherein said controller executes data rewriting, if the number of times of rewriting for a block to which data should be rewritten in said refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.

8. A nonvolatile semiconductor memory device comprising:
a nonvolatile memory unit; and
a controller that can control refresh processing for rewriting data in a block of blocks assumed to be erasable units in said nonvolatile memory unit into another block different from the block,
wherein an address registry area is provided in said nonvolatile memory unit, and
wherein said controller registers for management an area of said nonvolatile memory unit, the area in which an error occurrence has been found during said refresh processing into said address registry area, and, each time a refresh trigger occurs, said controller executes refresh processing for said first area and said second area, such that a refresh frequency for the area registered in said address registry area will become higher than a refresh frequency of data in an area not registered in said address registry area.

9. The nonvolatile semiconductor memory device according to claim 8, wherein said controller registers for management an area of said nonvolatile memory unit, the area in which an error occurrence has been found during said refresh processing into said address registry area in another semiconductor chip different from a semiconductor chip to which that area belongs.

10. The nonvolatile semiconductor memory device according to claim 9, wherein said controller multiplexes data in said first area and said controller executes data rewriting, if the number of times of rewriting for a block to which data should be rewritten in said refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.

11. The nonvolatile semiconductor memory device according to claim 8,
wherein said refresh trigger includes input of a predefined command from outside,
wherein an existing command to said nonvolatile semiconductor memory device is used as said predefined command, and
wherein when an address exceeding a maximum address in said nonvolatile semiconductor memory device has been specified by said existing command, said controller regards said existing command as a command to initiate said refresh processing.

12. The nonvolatile semiconductor memory device according to claim 8, wherein said controller multiplexes data in said first area.

13. The nonvolatile semiconductor memory device according to claim 11, wherein said controller multiplexes data within a same block in said first area.

14. The nonvolatile semiconductor memory device according to claim 8, wherein said controller executes data rewriting, if the number of times of rewriting for a block to which data should be rewritten in said refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.

15. A nonvolatile semiconductor memory device comprising:
a nonvolatile memory unit; and
a controller that can control refresh processing for rewriting data in a block of blocks assumed to be erasable units in said nonvolatile memory unit into another block different from the block,
wherein said controller executes data rewriting, if the number of times of rewriting for a block to which data should be rewritten in said refresh processing is less than an upper limit for the number of times of rewriting depending on the number of times of power-on, and aborts the data rewriting, if the number of times of rewriting for the block to which data should be rewritten has reached the upper limit for the number of times of rewriting depending on the number of times of power-on.
